(19) United States
(12) Patent Application Publication
(10) Pub. No.: US 2018/0244188 A1
(43) Pub. Date: Aug. 30, 2018

(54) Multiple Position Rear Tie Down Brackets for Motorcycles

(71) Applicant: Yelvington Trikes, LLC, Seminole, FL (US)

(72) Inventors: William Dewitt, Seminole, FL (US); Joseph Kruger, Seminole, FL (US); Steven Oberholtzer, Seminole, FL (US)

(21) Appl. No.: 15/444,890

(22) Filed: Feb. 28, 2017

(51) Int. Cl. B60P 7/08; B60P 3/07

(52) U.S. Cl. CPC B60P 7/0807; B60P 7/0869; B60P 3/07

(57) ABSTRACT

A pair of multiple position tie down brackets that fit between the mounting hole patterns of the rear pegs of certain year, brand, and model motorcycles. The tie down brackets allow for a more robust and attractive mounting point to secure the motorcycle to a trailer than through conventional means; whether routing a tie down strap around the passenger foot pegs, through the saddlebag supports, or through the rear wheel. This helps avoid the possibility of damaging, bending, or scratching the rear wheel, passenger foot pegs, or saddlebag supports. Additionally, machined slots in the tie down brackets allow for the rider to adjust the rear brackets or passenger foot pegs in multiple positions to suit rider comfort and safety.

### BACKGROUND OF THE INVENTION

The invention pertains to a pair of left and right multiple position tie down brackets. The improved tie down brackets allow for the same style bracket to be adapted to the different bolt patterns for passenger foot pegs on certain models, brands, and years of motorcycles. The multiple position feature is achieved through the use of machined slots on the improved tie down brackets that allow the rider to adjust the rear tie down brackets or rider pegs to suit rider comfort and safety. The tie down brackets allow for a more robust and attractive mounting point to secure the motorcycle to a trailer than through conventional means. Conventionally, motorcycles are tied down during transport by routing a tie down strap around the passenger foot pegs, through the saddlebag supports, or through the rear wheel. Any of these methods can damage, bend, or scratch the aforementioned components.

### DESCRIPTION OF THE PRIOR ART

In the Bugoon & Ricci U.S. Pat. No. 6,171,034, the prior art consists of an upper front frame mounted clamp that attaches to the left and right front fork tubes of a motorcycle. These clamps only fit tubes of one diameter and do not help secure the rear of the motorcycle as the improved multiple position tie downs of the invention do.

In the Bauer U.S. Pat. No. 8,348,561, the art consists of a clamp mounted to the bottom front of a motorcycle frame. The prior art consists also of a receiving clamp mounted to a flat trailer. The prior art relies on the motorcycle being pushed onto the trailer until the clamp on the bottom front of the motorcycle frame engages the receiver mounted on the trailer. The two clamps then engage and hold down the front of the motorcycle. The prior art is limited in its scope insomuch that the motorcycle equipped with the clamp must always be used with a trailer equipped with the receiver mounted to the trailer in a fixed position. The improved art of the multiple position tie down brackets allows the motorcycle to fit anywhere on the trailer platform and secures the rear of the motorcycle.

### SUMMARY OF THE INVENTION

In general, the invention uses the bolt pattern of the passenger foot pegs of certain models, brands, and years of motorcycles to allow a left and right tie down bracket to be mounted between the existing passenger foot pegs and the mounting holes on the motorcycle frame.

The improved tie down brackets replace the need to route a strap around the passenger foot pegs, through the saddlebag supports, or through the rear wheel. Each of these tie down methods have the potential to bend, scratch, or mar the finish of the aforementioned components. The tie down brackets instead provide a more robust, attractive, and permanent mounting location for tie down straps to attach.

### BRIEF DESCRIPTION OF THE DRAWINGS

FIG. 1 is a right-side view of the right rear tie down bracket unmounted.

FIG. 2 is a right-side view of a motorcycle with the tie down bracket mounted between the passenger foot peg and motorcycle frame.

FIG. 3 is a rear view of a motorcycle on a transport trailer showing the rear wheel of the motorcycle secured to the trailer by conventional tie down straps.

FIG. 4 is a rear view of a motorcycle on a transport trailer showing the rear of the motorcycle held down by the improved tie down brackets and straps.

FIG. 5 is a plan view of a motorcycle on a transport showing the front of the motorcycle being held down with conventional tie down brackets and straps, and the rear being held down with the improved tie down brackets and straps.

FIG. 6A is an exploded view of the improved tie down bracket being installed between the frame and passenger foot peg on a motorcycle

FIG. 6B is a detail view of FIG. 6A showing a closer view of the improved tie down bracket being installed between the frame and passenger foot peg on a motorcycle

### DETAILED DESCRIPTION OF THE INVENTION

The device offers significant improvements over existing tie down brackets by allowing one style of rear tie down brackets to fit between the existing passenger foot pegs of certain model motorcycles.

The use of elongated slots in the improved tie down brackets allows the existing passenger foot pegs to still be adjusted to suit rider comfort and safety.

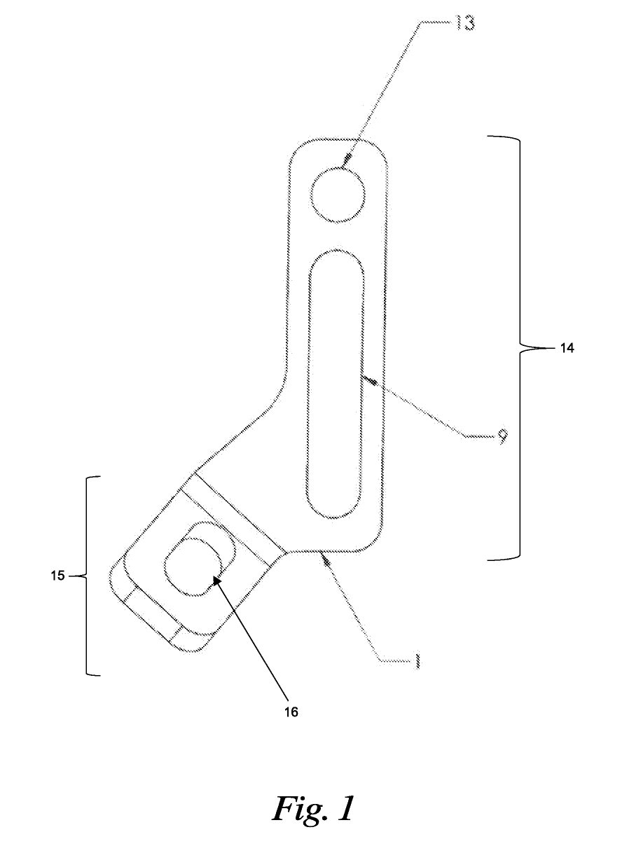

Now referring to FIG. 1, this is a right-side view of the right rear tie down bracket 1 unmounted. The view shows the bracket 1 in projected view. The bracket 1 has two primary sections, a mounting section 14 and a tie down section 15. The mounting section 14 includes the mounting hole 13 and the elongated slot 9, both of which mount to the bike, while the elongated slot 9 also allows for the multiple position adjustment of the passenger foot peg 3. The tie down section 15 includes the tie down slot 16. The tie down slot 16 is configured to interface with a strap, latch, hook, or other suitable securing mechanism to hold the motorcycle in place on a trailer during transport.

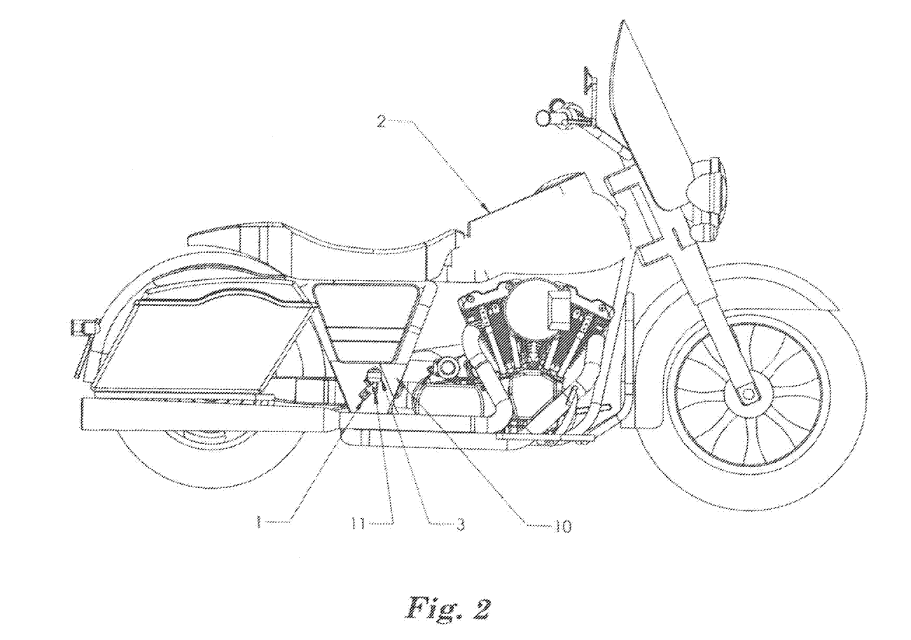

Now referring to FIG. 2, another key component of the embodiment is the improved method of mounting the rear tie down brackets 1 using the existing mounting pattern 11 of certain motorcycle passenger foot pegs 3. The improved bracket 1 fits between the frame 10 of certain motorcycles 2 and the existing passenger foot pegs 3 mount over the tie down bracket 1.

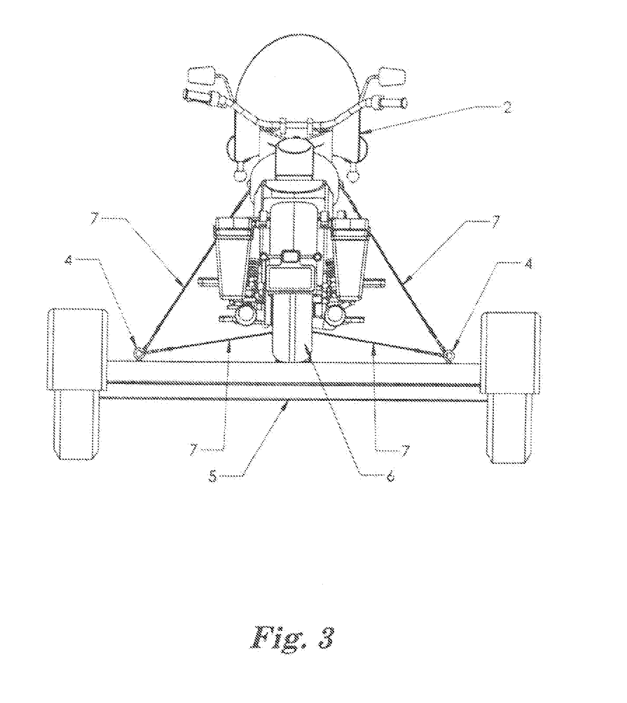

Now referring to FIG. 3, this is a rear view of the rear wheel 6 of a motorcycle 2 being secured by a conventional tie down strap 7 through the rear wheel 6 and to the trailer 5 by the tie down points 4.

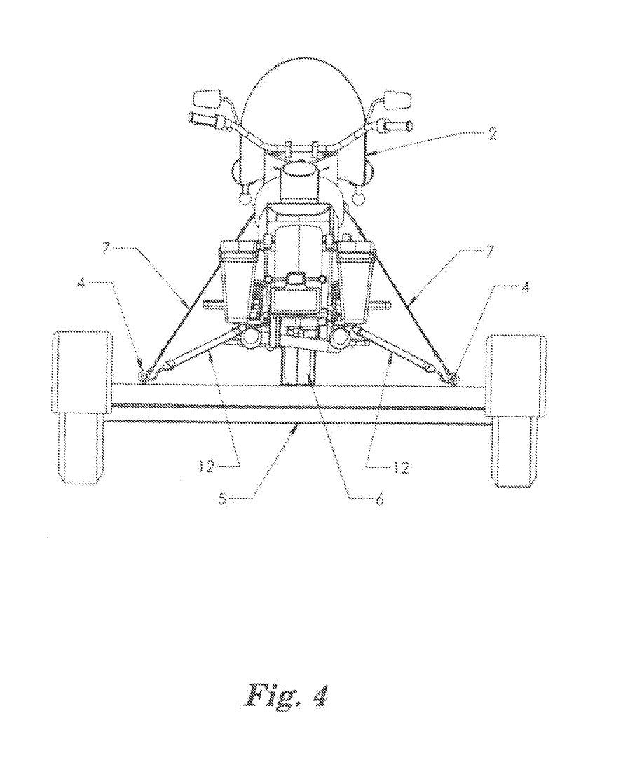

Now referring to FIG. 4, this is a rear view of a motorcycle 2 mounted on a transport trailer 5 showing the rear of the motorcycle 2 being secured to the transport trailer 5 by the tie down straps 7 and the bracket straps 12 to the tie down points 4.

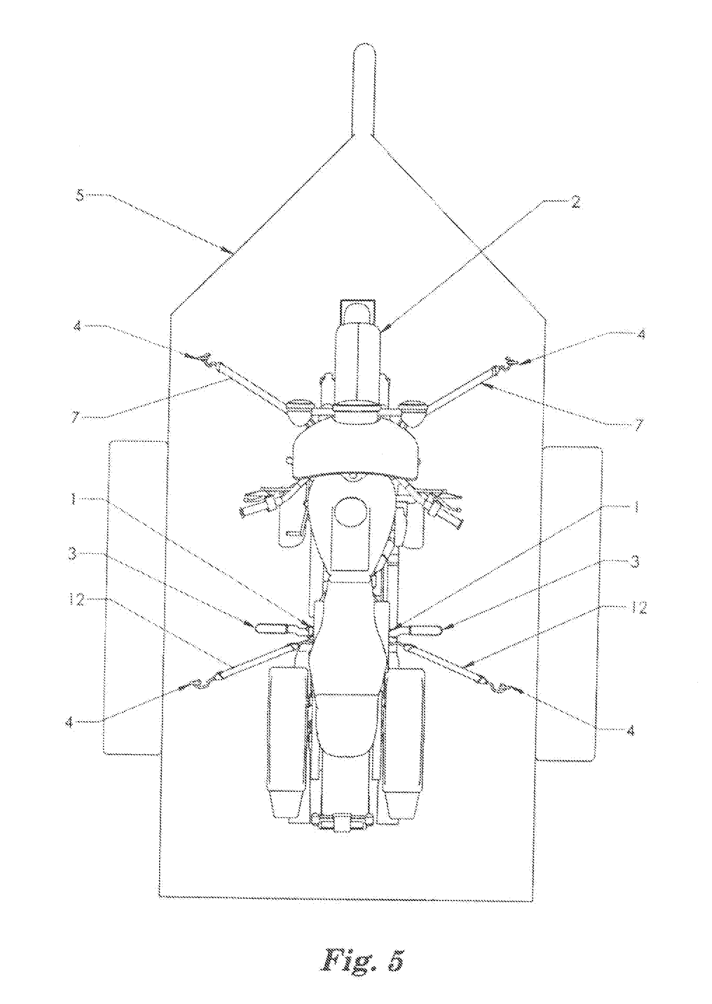

Now referring to FIG. 5, this is a plan view of a motorcycle 2 being secured to the transport trailer 5 by tie down straps 7 and the bracket straps 12 in the rear being secured with improved tie down brackets 1.

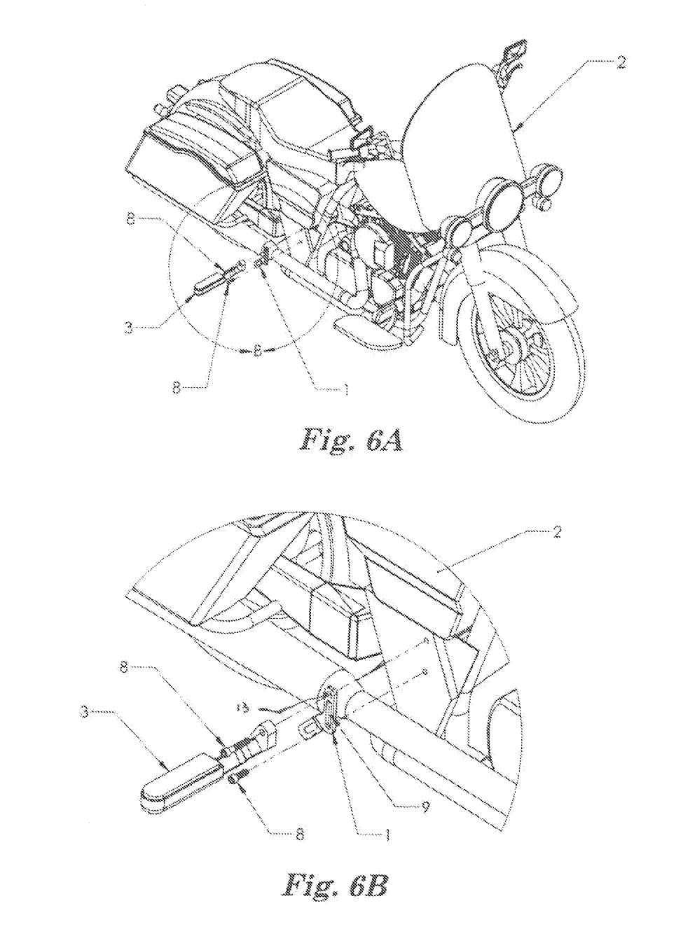

Now referring to FIGS. 6A & 6B, these are exploded views of the improved tie down brackets being installed between the motorcycle 2 frame 10 and passenger foot peg 3 using the tie down bracket bolts 8 with existing hole pattern 11 on the motorcycle 2 frame 10, as well as bracket mounting hole 13 and elongated slot 9 in the improved tie down bracket 1.

### LIST OF REFERENCE NUMERALS

1. TIE DOWN BRACKET
2. MOTORCYCLE
3. PASSENGER FOOT PEG
4. TRAILER TIE DOWN POINTS
5. TRAILER
6. MOTORCYCLE REAR WHEEL
7. TIE DOWN STRAPS
8. TIE DOWN BRACKET BOLTS
9. ELONGATED SLOT
10. MOTORCYCLE FRAME
11. EXISTING MOUNTING PATTERN
12. BRACKET STRAPS
13. BRACKET MOUNTING HOLE
14. MOUNTING SECTION
15. TIE DOWN SECTION
16. TIE DOWN SLOT

1. A pair of rear mounted tie down brackets for a motorcycle comprising:
a pair of tie down brackets that can be mounted between the rear of a frame of the motorcycle and the existing passenger foot pegs of the motorcycle.

2. (canceled)

3. The pair of rear mounted tie down brackets for a motorcycle of claim 1, the brackets comprising:
a mounting section having an elongated slot and a mounting hole;
a tie down section having a tie down slot;
wherein the mounting section is mounted between the motorcycle frame and a foot peg; and
whereby the motorcycle is secured by an attachment mechanism and the tie down slot.

4. The pair of rear mounted tie down brackets for a motorcycle of claim 1, the brackets comprising:
a first section, the first section having a first slot,
a second section, the second section having a hole and a second slot, and
wherein the first section and the second section join at a right angle, and
wherein the second slot is elongated to allow for multiple mounting positions of the foot pegs.

5. The pair of rear mounted tie down brackets for a motorcycle of claim 3, wherein the second section is secured between the frame of the motorcycle and the foot peg.
